(19) United States
(12) Patent Application Publication
(10) Pub. No.: US 2015/0142559 A1
(43) Pub. Date: May 21, 2015

(54) CUSTOMERS COMPARISON AND TARGETING METHOD

(71) Applicant: SNECMA, Paris (FR)

(72) Inventors: Didier Jeannel, Champigny Sur Marne (FR); Renan Gicquel, Paris (FR)

(73) Assignee: SNECMA, Paris (FR)

(21) Appl. No.: 14/084,875

(22) Filed: Nov. 20, 2013

(51) Int. Cl. G06Q 30/02

(52) U.S. Cl. CPC G06Q 30/0254
USPC 705/14.52

(57) ABSTRACT

A computer processor implemented process for identifying a template associated with a queried customer, such that a type and at least one subject of the template are selected based on (i) an influence score of the queried customer, (ii) an interest score of the queried customer, and (iii) a sensitivity profile of the queried customer. The process includes identifying sensitivity variables, influence variables, and interest variables, collecting data for these variables, processing sensitivity data to position the queried customer on a first map, processing an influence score and an interest score of the queried customer to position the queried customer on a second map, and identifying a template type for the queried customer, based on the second map and at least one template subject based on the first map. The process outputs a template with the identified template type and the identified at least one subject for the queried customer.

### BACKGROUND

The current disclosure relates to the field of identifying a template for a customer, where a type and subject of the template are based on customer characteristics.

Conventionally, sales executives prepare for trade negotiations based on their personal experience with the market and subjective judgments of customers. Sales executives can use either marketing studies, which aim to identify customer groupings, or market studies, which aim to position a brand or product within the market to help them target existing or potential customers. Current studies do not integrate information on the customer's position and influence in the market with information regarding the products in which the customers are interested.

In the prior art, there is no systematic template selection method which permits a salesperson to systematically customize a sales presentation to be both adequate and effective for a current or new customer.

### SUMMARY

A computer processor implemented process for identifying a template associated with a queried customer, such that a type and at least one subject of the template are selected based on (i) an influence score of the queried customer, (ii) an interest score of the queried customer, and (iii) a sensitivity profile of the queried customer. The computer processor implemented process includes identifying sensitivity variables, influence variables, and interest variables, collecting data for these variables, processing sensitivity data to position the queried customer on a first map, processing an influence score and an interest score of the queried customer to position the queried customer on a second map, and identifying a template type for the queried customer, based on the second map and at least one template subject based on the first map. The computer processor implemented process outputs a template with the identified template type and the identified at least one subject for the queried customer.

### BRIEF DESCRIPTION OF THE DRAWINGS

The characteristics and advantages of an exemplary embodiment are set out in more detail in the following description, made with reference to the accompanying drawings.

FIG. 1 depicts a schematic of a selection process for sensitivity variables;

FIG. 2A depicts a schematic of a method to obtain a sensitivity map;

FIG. 2B depicts a map of data collected for a sensitivity map;

FIG. 2C depicts a schematic of a sensitivity map;

FIG. 3A depicts a schematic of a method to obtain an influence and interest map;

FIG. 3B depicts a schematic of an influence and interest map;

FIG. 4A depicts a schematic of the integration of the sensitivity map and influence and interest map into the CRM tool;

FIG. 4B depicts a sensitivity map;

FIG. 4C depicts an influence and interest map;

FIGS. 5A-B depict a schematic of the Template Selection tool; and

FIG. 6 depicts a schematic of the CRM tool hardware.

### DETAILED DESCRIPTION OF THE PREFERRED EMBODIMENTS

An exemplary embodiment of the customer targeting method targets existing and potential customers through a customized sales campaign. An exemplary embodiment of the method provides a formal approach to trade negotiations, and helps sales representatives gain knowledge of their customers' interests.

One advantage of an exemplary embodiment of the method is the ability to reduce the number and duration of business trips, by allowing sales presentations to be tailored to customer expectations. Another advantage of an exemplary embodiment is the ability to improve sales capacity by following both the needs and strategies of customers, as well as market trends.

These and other objects, advantages, and features of the exemplary customer targeting method described herein will be apparent to one skilled in the art from a consideration of this specification, including the attached drawings.

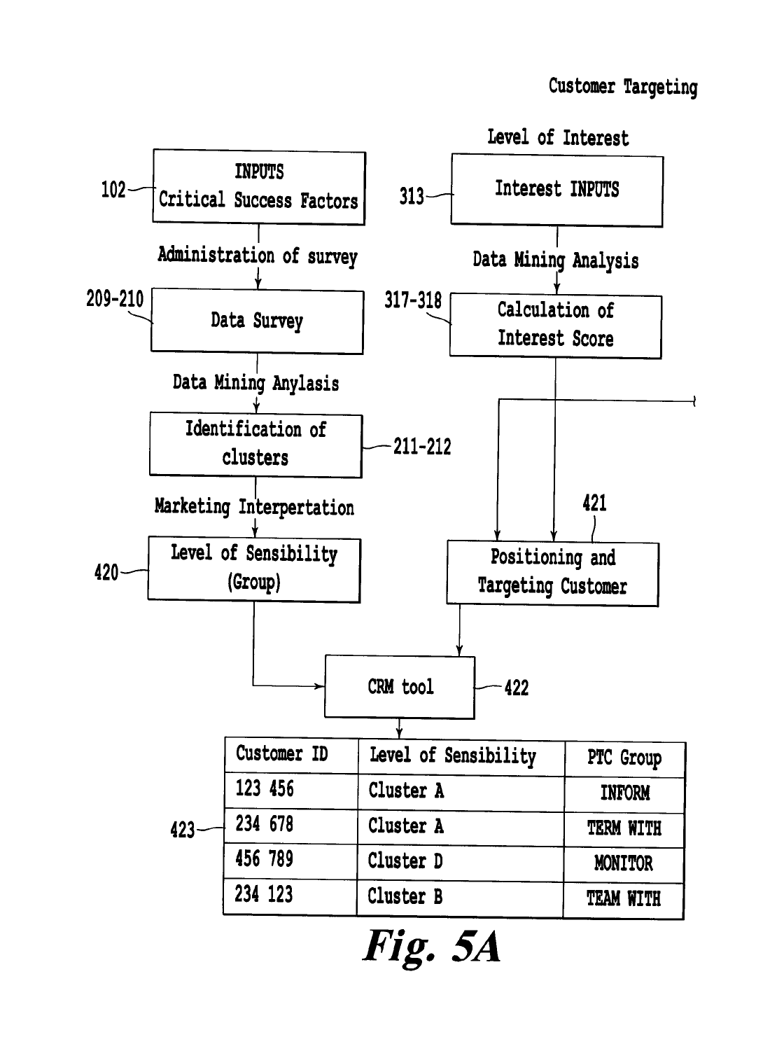

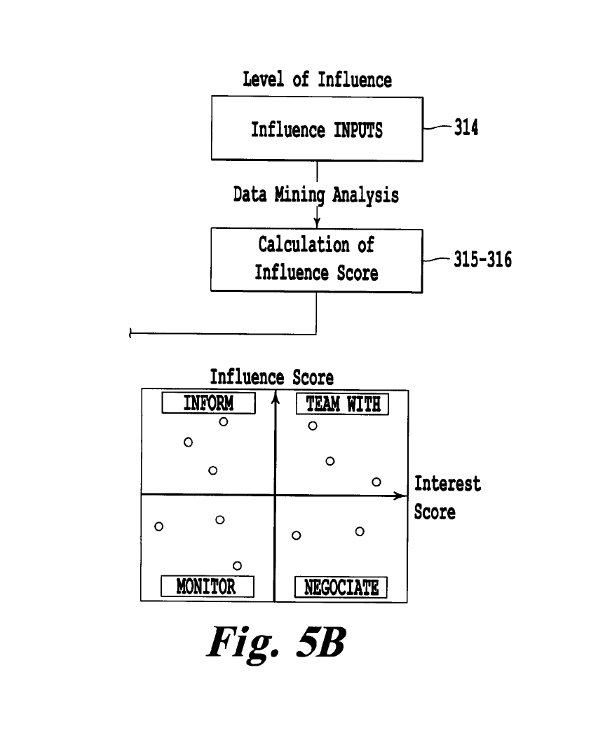

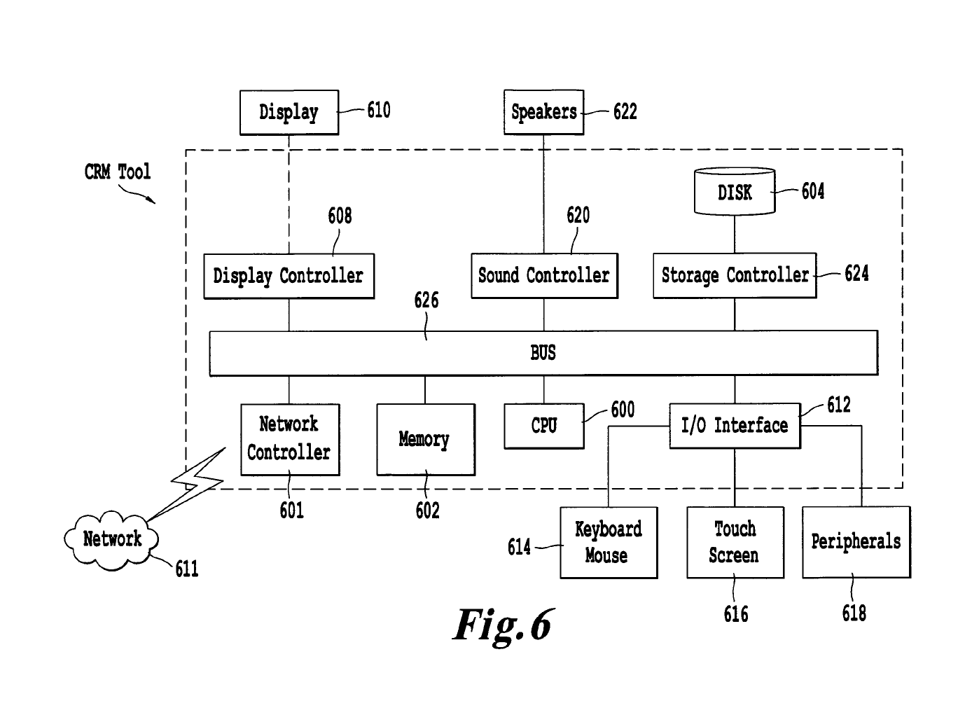

Referring to FIGS. 5A-B, in an exemplary embodiment the customer targeting method is carried out with a template selection tool (TST) which performs both a customer sensitivity analysis, and a customer targeting analysis, with the results of both integrated in the Customer Relationship Management (CRM) tool (422), to provide an output (423) for the sales staff. In an exemplary embodiment, the template selection tool is a specially programmed computer. In an exemplary embodiment, the targeting method combines customer characterization and customer interest and influence levels to determine if a customer should be approached, with which approach, and which products or aspects should be discussed. The template selection tool exemplified in the embodiment of FIGS. 5A-B provides as an output (423) a template with the appropriate approach type and at least one subject relevant to the customer. In an exemplary embodiment, the output template is in the form of an electronic document including an outline, as well as charts and tables representing data relevant to the queried customer's interests. In another exemplary embodiment, the output template is in the form of an electronic document including a table with a customer identifier, the customer level of sensitivity, and the customer position on an interest and influence map. In exemplary embodiments the output template can be used for operational and commercial activities such as client meeting and negotiations.

In an exemplary embodiment of the method, inputs (102, 313, 314) are selected from a large number of variables for both customer sensitivity analysis and customer targeting. In an exemplary embodiment, the selected variables are validated against past customer sales data to ensure an accurate customer characterization is obtained. For example, an existing customer such as Air France is a high interest customer while Airbus' decision to purchase a new engine led several other companies to purchase the new engine, making it a high influence customer. In exemplary embodiments, customers may be airlines, aircraft manufacturers, or lessors, as airlines, i.e. Air France, or American Airlines operate the planes as the end customer, aircraft manufacturers, i.e. Airbus or Boeing make manufacturing and production decisions about the planes, and lessors, which have an ownership interest in the planes, make fleet decisions. In an exemplary embodiment, airlines tend to have a high influence, while aircraft manufacturers tend to be high interest customers, but airlines may also be high interest and aircraft manufacturers may be high influence customers. In some embodiments, customers may be both influence and interest customers. In other exemplary embodiments, other categories of customers may be characterized with the customer characterization method.

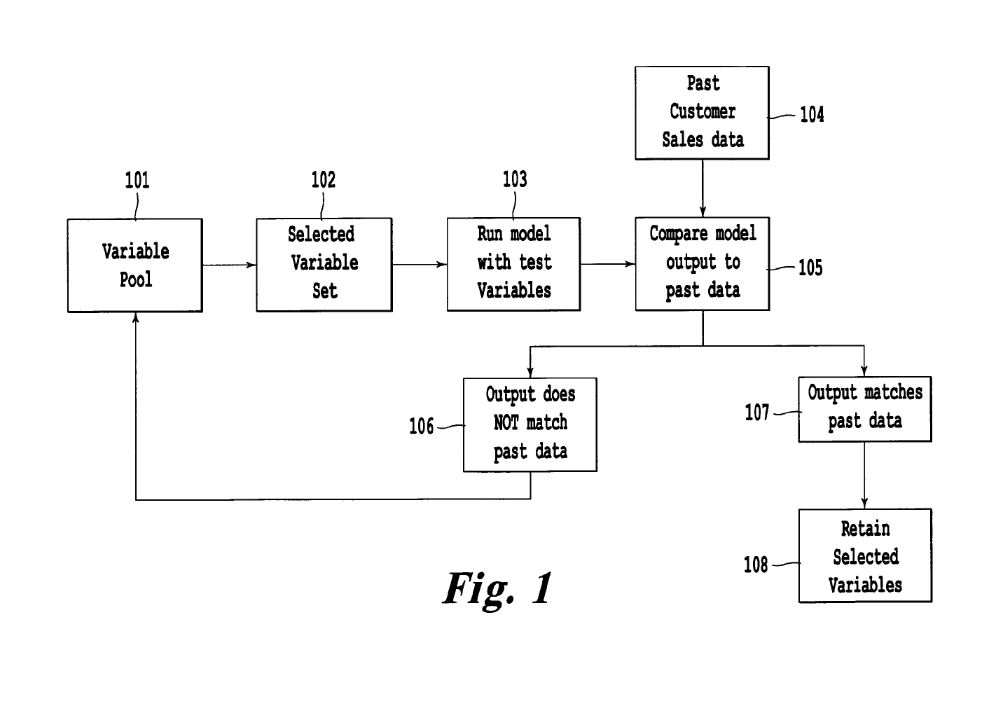

In an exemplary embodiment, selected variables are validated when using the method with these selected variables correctly identifies at least 50% of existing customers as high or low interest and high or low influence customers. For example, the method with the identified variables correctly identifies Air France as a high interest customer, and correctly identifies Airbus as a as a customer with a strong influence on the market. In an exemplary embodiment of the method, for each variable each customer has a different value. This allows a global analysis with the ability to compare and rank customers without any ties. Referring to the exemplary embodiment of FIG. 1, a set of sensitivity variables is selected from a variable pool (101). In an exemplary embodiment, the variable pool includes over 30 variables, which characterize market share, fleet size, and growth potential. The template selection tool is then used on the basis of the selected variable set (2) for known customers for which past sales data (104) is available, including which sales presentation was made, and the monetary amount of sales resulting from the sales presentation both direct and indirect if other customers were influenced. The output of the template selection tool is then compared (105) to past customer sales data to validate selected variable set. When the output template is in contradiction with past sales data (106), a new variable set is selected from the variable pool, and the process repeated until the template selection tool outputs a template which matches past customer data. In an exemplary embodiment the identified variables can be validated in a processor of the TST on existing customers and templates, by selecting a different set of variables until the template selection tool accurately matches existing customers and templates. When the output template is in agreement with past sales data (107), the identified variable set is retained (108) and used for future queried customers.

In an exemplary embodiment, the variable selection is performed by the template selection tool, with a processor of the computer identifying the sensitivity variables, influence variables, and interest variables. In an exemplary embodiment of the customer targeting method, the following sensitivity variables have been selected: availability, brand image, reliability, thrust, fuel burn, maintenance cost, CO2 emission, NOx emission, engine price, noise level, time on wing, environmental impact, services contract, warranty, and lease cost. In an exemplary embodiment, availability corresponds to the availability of products or services to customers. For example, some engines may be repaired in a larger number of maintenance centers, providing customers with greater flexibility regarding their flight routes. In an exemplary embodiment, brand image is measured by the percentage of layman who recognize a brand. In an exemplary embodiment questions to the customer incorporate elements related to both technical and commercial aspects of services provided.

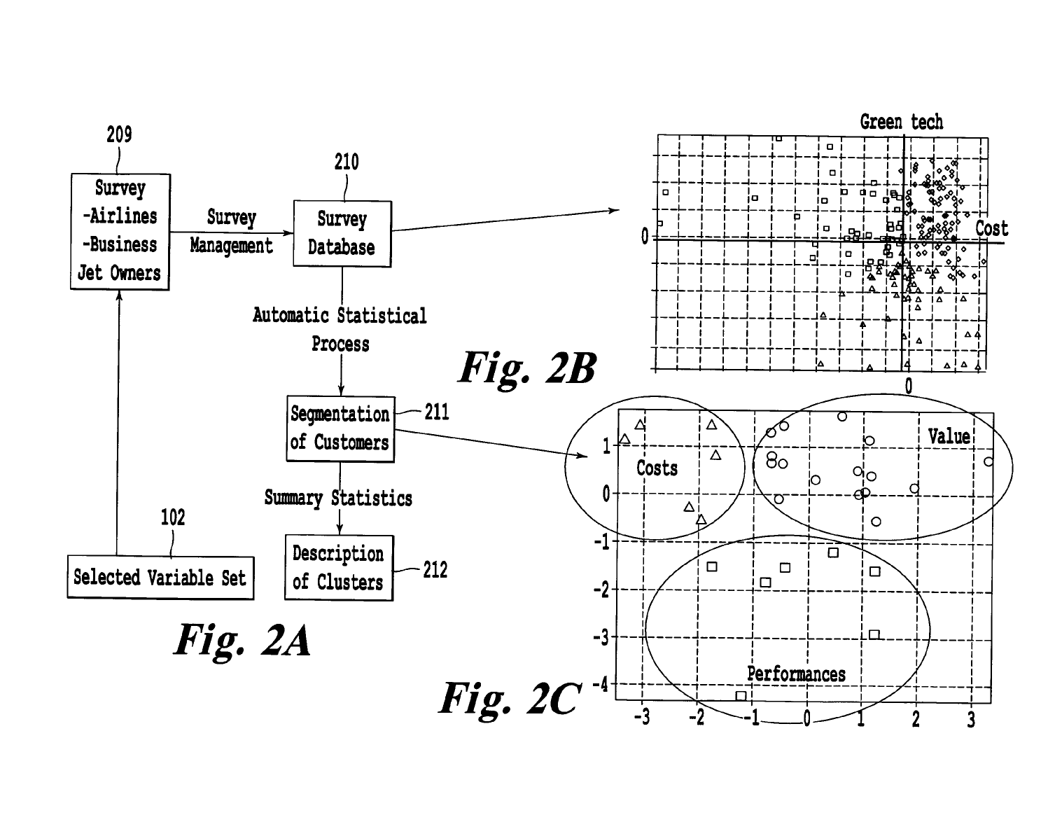

Referring to the exemplary embodiment of FIG. 2A, the selected sensitivity variable set is used to prepare a survey which can be sent to current and potential customers. In an exemplary embodiment, the sensitivity survey is sent out to customers on a regular basis, such as yearly, or every two years, to ensure that customer targeting by sales representatives remains up to date. Surveys questions are carefully worded to be easily understood by customers, while avoiding effects such as hindsight bias for customers. In an exemplary embodiment, multiple engines with different characteristics are presented, and the customers are required to rank the proposed engines. The engine rankings recorded by the customers can be used to reverse engineer which factors and/or areas of interest a customer prioritizes. In an exemplary embodiment, the surveys are quantitative, requiring customers to rank criteria relative to one another, and/or to provide numerical scoring for each criterion. Once surveys are returned from the customers, the data is processed, and stored in a survey database (210), a portion of which is represented in FIG. 2B. In an exemplary embodiment, surveys may be on-line surveys. In an exemplary embodiment, the database of the template selection tool stores, for each current or potential customer, sensitivity data provided by each surveyed customer for the selected sensitivity variables, influence data collected for the selected influence variables, and interest data collected for the selected interest variables. In an exemplary embodiment a semi-automated or automated statistical process mines the survey data to extract previously unknown patterns and provide a customer segmentation (211). Finally, the use of statistical regression allows the description of the clusters (212) obtained from segmentation, and described in FIG. 2C.

In an exemplary embodiment, for each new queried customer, the same steps (209, 210-212) are carried out and lead to identification of a sensitivity profile for the queried customer.

In an exemplary embodiment, a first method of data mining includes Principal Component Analysis (PCA) which regroups and summarizes information from a large data set. PCA identifies correlations between variables and uses orthogonal transformation to obtain, from possibly correlated variables, a set of linearly uncorrelated variables. In an exemplary embodiment, a second data mining method is Hierarchical Ascendant Classification (HAC), which achieves a classification of customers. In an exemplary embodiment, HAC is well suited for analyzing a data set with under 100 customers. With HAC, each customer is initially the only group in its cluster. HAG progressively regroups customers into common clusters by measuring the statistical distance between customers and grouping those closest to each other. The process is repeated until a set group of clusters is reached, or until all the clusters are equidistant from each other. In other exemplary embodiments, other statistical analysis methods may be used in lieu of, or in combination with PCA and HCA.

In an exemplary embodiment, as shown in FIG. 2B, a cluster plot can display customer groupings. This customer segmentation can be further summarized by indicating sensitivity clusters on a map, as shown in FIG. 2C. In the exemplary embodiment of FIG. 2C, a first cluster includes customers with cost as a primary concern, a second cluster includes customers for which performance is key, and a third cluster groups customers primarily focused on money value.

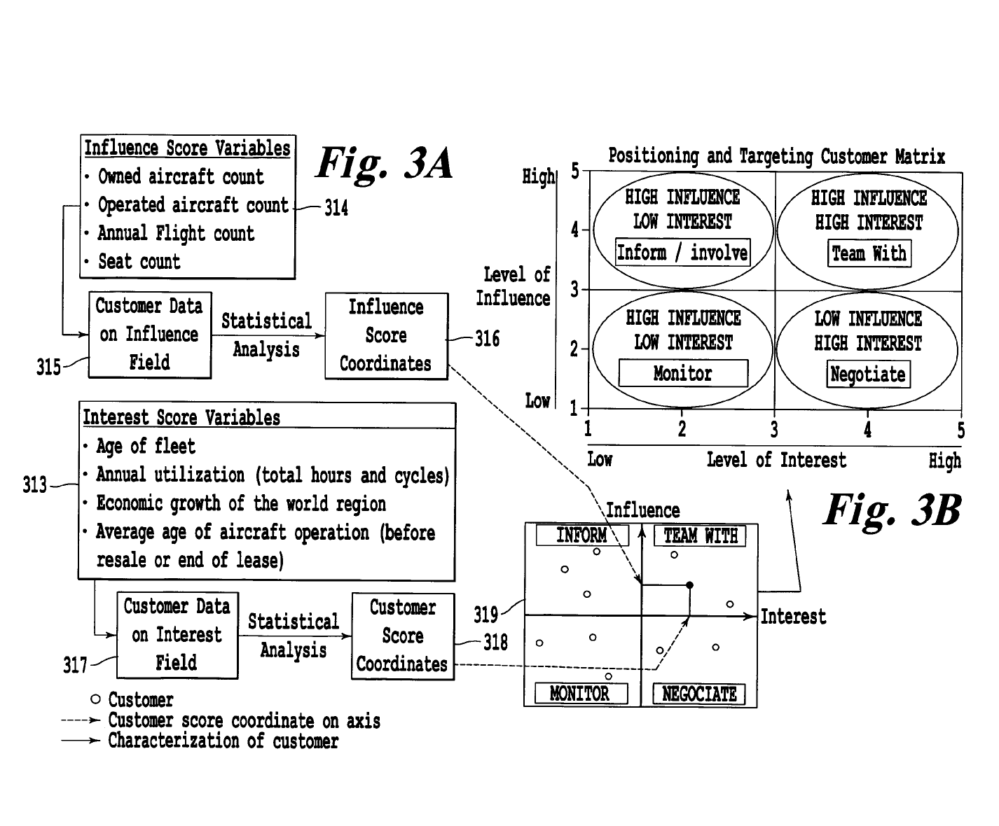

In an exemplary embodiment, in addition to the sensitivity level, the influence and interest levels of a customer are also determined to assess if a customer should be targeted, and if so with what type of template. As shown in the exemplary embodiment of FIG. 3B, customers with a normalized interest score greater than 3 are high interest, while customers with an interest score below 3 are low interest customers. Similarly, customers with an influence score above 3 are high influence, while customers with an influence score below 3 are low influence. In an exemplary embodiment, influence and interest values are normalized. In an exemplary embodiment, four quadrants are identified, with the quadrants of equal size. In another exemplary embodiment, the four quadrants are unevenly sized. For example, there is a large span of high influence values, while the plotted customers have similar interest values. In an alternate embodiment, more than four zones are identified. For example, the map may be divided into six zones, with high, medium and low interest zones, as well as high, medium and low influence zones. As shown in the exemplary embodiment of FIGS. 5A-B, a customer query acts as an input to the template selection tool. In an exemplary embodiment, a sales representative queries a customer in the template selection computer database, and the computer processor implemented process of the template selection tool selects a template associated with the queried customer, as determined by a template type and at least one subject, which are based on (i) an influence score of the queried customer, (ii) an interest score of the queried customer, and (iii) a sensitivity profile of the queried customer.

In an exemplary embodiment, the influence level of a customer indicates the potential impact of a queried customer on the market, i.e. how many other customers will follow the influence of the queried customer with respect to product choices and how the market trends will be affected by the behavior of the queried customer. The interest level of a customer measures the willingness of the queried customer to invest in a product or service. In an exemplary embodiment, influence variables and interest variables are selected similarly to the sensitivity variables. In an exemplary embodiment, the selected influence variables (314) include the number of owned aircraft, the number of operated aircraft, the annual number of flights, and the number of seats per aircraft. In an exemplary embodiment, the number of owned or operated aircraft reflects company size, and indicates a high influence customer. In an exemplary embodiment, a high annual number of flights is indicative of a large market share for a customer. In an exemplary embodiment, a high number of seats per aircraft indicates larger aircraft and a customer's willingness to invest.

In an exemplary embodiment, the selected interest variables (313) include the age of the fleet, the annual utilization in total hours and cycles, the economic growth of the world regions where the fleet is operated, and the average age of operation of aircraft before resale or before the lease expires. In an exemplary embodiment, an older fleet indicates a higher interest customer, as the customer will required a fleet replacement or fleet servicing, as well as a higher influence customer, as most legacy customers have aging fleets. In an exemplary embodiment, a higher annual utilization in total hours indicates that the customer invests heavily in fleet maintenance, and may be interested in a new fleet. In an exemplary embodiment, a lower age of operation before resale indicates a higher interest customer, with a shorter equipment turnaround.

In an exemplary embodiment, as shown in FIG. 3A, for all current and potential customers data is collected for each selected influence variable (315) and interest variable (317). In this exemplary embodiment, the template selection tool performs statistical analysis on the influence data and on the interest data and computes an influence score (316) and an interest score (318) for each customer. In an exemplary embodiment, for each customer an influence and interest score pair corresponds to a coordinate pair on the influence and interest map (319), as shown in FIG. 3B.

In an exemplary embodiment, for each queried customer, the template selection tool processor processes the sensitivity data for the queried customer to identify a sensitivity profile, and positions the customer on the cluster map. The process further identifies the cluster or sensitivity profile of the queried customer, based on the queried customer's position on the cluster map.

In an exemplary embodiment, for each queried customer, a processor of the computer computes an influence score of the queried customer based on the collected influence data for the queried customer, and computes an interest score of the queried customer based on the collected interest data for the queried customer.

On this exemplary influence and interest map, customers with coordinate pairs within the high influence and low interest quadrant are customers which can be informed and involved. The high influence and high interest quadrant of this exemplary map includes customers with which commercial partnerships are highly desirable. For example special rates may be negotiated, or an offer may be customized. The low influence and low interest quadrant corresponds to customers which will be monitored for change in either interest or influence before pursuing. These low influence and low interest customers are identified as having the potential to be influenced by changes in either the market or visible customers, i.e. customers which fall in the high influence half of the map. Finally, customers in the low influence and high interest quadrant are customers with which negotiations can be entered regarding preferential pricing, exclusive services, delivery conditions, or other benefits to acquire their business.

In an exemplary embodiment, for each queried customer, a processor of the computer determines the position of a queried customer on an interest and influence map, by using the influence score and the interest score of the queried customer as a coordinate pair, and identifies the nature of the quadrant in which the customer is located.

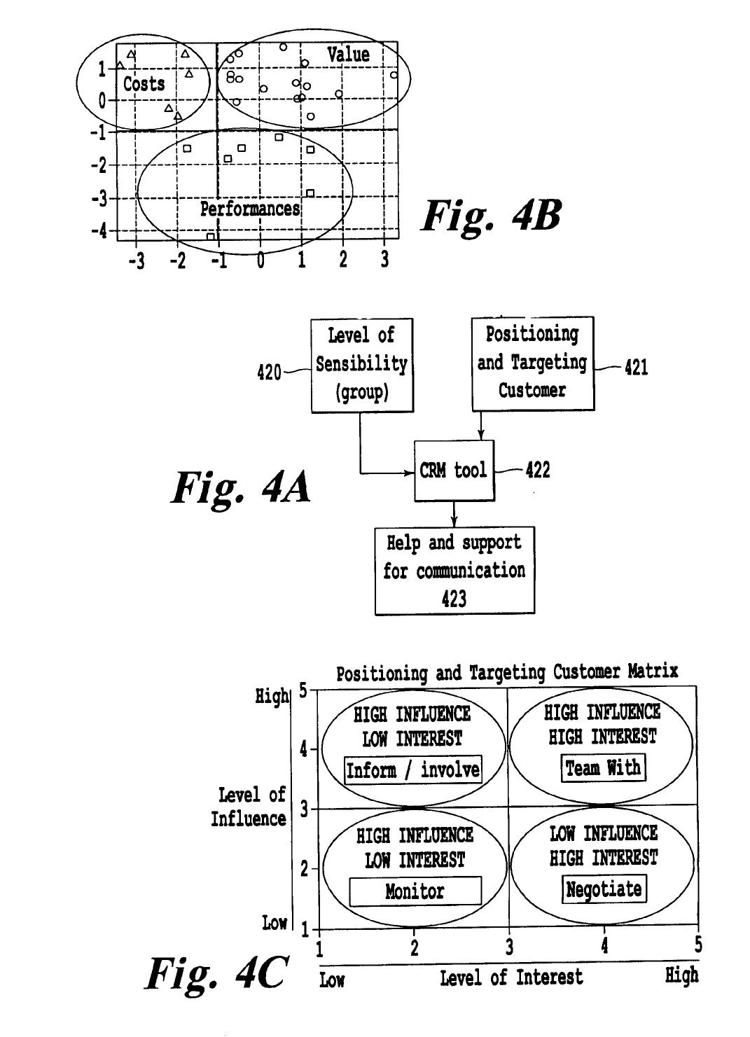

Referring to the exemplary embodiment shown in FIG. 4A, data from both the cluster map of FIG. 4B, indicating each customer's level of sensitivity (420), and the interest and influence map of FIG. 4C, which positions the customer in one of four target groups (421) is integrated in the CRM tool. In an exemplary embodiment, the CRM tool outputs at least one sales presentation template for the sales representatives to use with a queried customer. In an exemplary embodiment, the CRM Tool outputs a list of templates for the queried customer, where each template includes a subject that matches the level of sensitivity of the customer, and is of a type that matches the interest and influence level of the customer.

As shown in the exemplary embodiment of FIGS. 5A-B, customer sensitivity and customer targeting operations are carried out in parallel within the Template Selection Tool, resulting in the customer sensitivity information on a cluster map, and the position of the customer on an influence and interest map.

Next, a hardware description of the template selection tool according to exemplary embodiments is described with reference to FIG. 6. In FIG. 6, the template selection tool may include a CPU 600 which performs the processes described above. The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the template selection tool communicates, such as a server or computer.

Further, the claimed advancements may be provided as a utility application, background daemon, or component of an operating system, or combination thereof, executing in conjunction with CPU 600 and an operating system such as Microsoft Windows 7, UNIX, Solaris, LINUX, Apple MAC-OS and other systems known to those skilled in the art.

CPU 600 may be a Xenon or Core processing circuit from Intel of America or an Opteron processing circuit from AMD of America, or may be other processing circuit types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processing circuits cooperatively working in parallel to perform the instructions of the inventive processes described above.

The template selection tool in FIG. 6 may also include a network controller 606, such as an Intel Ethernet PRO network interface card from Intel Corporation of America, for interfacing with network 611. As can be appreciated, the network 611 can be a public network, such as the Internet, or a private network such as an LAN or WAN network, or any combination thereof and can also include PSTN or ISDN sub-networks. The network 611 can also be wired, such as an Ethernet network, or can be wireless such as a cellular network including EDGE, 3G and 4G wireless cellular systems. The wireless network can also be WiFi, Bluetooth, or any other wireless form of communication that is known.

The template selection tool may further include a display controller 608, such as a NVIDIA GeForce GTX or Quadro graphics adaptor from NVIDIA Corporation of America for interfacing with display 610, such as a Hewlett Packard HPL2445w LCD monitor. A general purpose I/O interface 612 may interface with a keyboard and/or mouse 614 as well as a touch screen panel 616 on or separate from display 610. General purpose I/O interface may also connect to a variety of peripherals 618 including printers and scanners, such as an OfficeJet or DeskJet from Hewlett Packard.

The general purpose storage controller 624 may connect the storage medium disk 604 with communication bus 626, which may be an ISA, EISA, VESA, PCI, or similar, for interconnecting all of the components of the diagnostic tool. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

Because many possible embodiments may be made of the invention without departing from the scope thereof, it is to be understood that all matter herein set forth or shown in the accompanying drawings is to be interpreted as illustrative and not in a limiting sense.

1: A computer processor implemented process for identifying a template associated with a queried customer from a group of customers, wherein a type and at least one subject of the template are selected based on (i) an influence score of the queried customer, (ii) an interest score of the queried customer, and (iii) a sensitivity profile of the queried customer, comprising:
identifying, in a processor of the computer, sensitivity variables, influence variables, and interest variables for the group of customers,
processing, in a processor of the computer, collected sensitivity data stored in memory for the queried customer, to position the queried customer on a first map,
identifying, in a processor of the computer, a sensitivity profile for the queried customer, based on the position of the queried customer on the first map,
computing, in a processor of the computer, an influence score of the queried customer based on the collected influence data for the queried customer,
computing, in a processor of the computer, an interest score of the queried customer based on the collected interest data for the queried customer,
processing, in a processor of the computer, the influence score and the interest score of the queried customer to position the queried customer on a second map,
identifying in a processor of the computer, an area of the second map in which the customer is located,
identifying a template type for the queried customer, based on the identified area of the second map in which the queried customer is located, and
identifying at least one template subject based on the identified sensitivity profile of the queried customer in the first map, and
outputting a template with the identified template type for the queried customer, and the identified at least one subject for the queried customer.

2: The computer processor implemented process of claim 1, further comprising:
collecting, in a memory of the computer, sensitivity data provided by each customer for the selected sensitivity variables,
collecting, in a memory of the computer, influence data for each customer for the selected influence variables,
collecting, in a memory of the computer, interest data for each customer for the selected interest variables.

3: The computer processor implemented process of claim 1, wherein the identifying, in a processor of the computer, of the sensitivity variables, influence variables, and interest variables includes:
identifying, in a processor of a computer, a set of variables;
validating the process of claim 1 with existing customers and templates; and
selecting a different set of variables until the process of claim 1 accurately matches existing customers and templates.

4: The computer processor implemented process of claim 1, wherein the second map is divided in four quadrants.

5: The computer processor implemented process of claim 4, wherein a first type of template corresponds to a first quadrant of the second map, a second type of template corresponds to a second quadrant of the second map, a third type of template corresponds to a third quadrant of the second map, and a fourth type of template corresponds to a fourth quadrant of the second map.

6: The computer processor implemented process of claim 1, wherein the selected sensitivity variables are at least one of: availability, lease cost, brand image, reliability, thrust, fuel burn, CO2 emission, NOx emission, engine price, noise level, time on wing, green technology, services contract, warranty and maintenance cost.

7: The computer processor implemented process of claim 1, wherein the selected interest variables are at least one of age of fleet, annual utilization, economic growth of a world region, and average age of aircraft operation.

8: The computer processor implemented process of claim 1, wherein the selected influence variables are at least one of owned aircraft count, operated aircraft count, annual flight count, and seat count.

9: The computer processor implemented process of claim 1, wherein the queried customer is queried by inputting an identification query, in a processor of the computer.

10: The computer processor implemented process of claim 1 wherein the selected template is selected from multiple templates stored in a database of the computer.

11: A system for identifying a template associated with a queried customer from a group of customers, wherein a type and at least one subject of the template are selected based on (i) an influence score of the queried customer, (ii) an interest score of the queried customer, and (iii) a sensitivity profile of the queried customer, comprising:
means for identifying sensitivity variables, influence variables, and interest variables for the group of customers,
means for processing collected sensitivity data stored in memory for the queried customer, to position the queried customer on a first map,
means for identifying a sensitivity profile for the queried customer, based on the position of the queried customer on the first map,
means for computing an influence score of the queried customer based on the collected influence data for the queried customer,
means for computing an interest score of the queried customer based on the collected interest data for the queried customer,
means for processing in a processor of the computer, the influence score and the interest score of the queried customer to position the queried customer on a second map,
means for identifying an area of the second map in which the customer is located,
means for identifying a template type for the queried customer, based on the identified area of the second map in which the queried customer is located, and
means for identifying at least one template subject based on the identified sensitivity profile of the queried customer in the first map, and
means for outputting a template with the identified template type for the queried customer, and the identified at least one subject for the queried customer.

12: A system for identifying a template associated with a queried customer from a group of customers, wherein a type and at least one subject of the template are selected based on (i) an influence score of the queried customer, (ii) an interest score of the queried customer, and (iii) a sensitivity profile of the queried customer, comprising:
means for identifying a sensitivity profile for the queried customer on a first map,
means for identifying an area of a second map of interest and influence in which the customer is located,
means for identifying a template type for the queried customer, based on the identified area of the second map in which the queried customer is located, and
means for identifying at least one template subject based on the identified sensitivity profile of the queried customer in the first map, and
means for outputting a template with the identified template type for the queried customer, and the identified at least one subject for the queried customer.
